(19) United States
(12) Patent Application Publication
(10) Pub. No.: US 2025/0139573 A1
(43) Pub. Date: May 1, 2025

(54) APPARATUS AND METHOD FOR RECOVERING ERROR IN SUPPLY CHAIN TRANSACTION INFORMATION

(71) Applicant: YYSOFT CO., LTD., GYEONGGI-DO (KR)

(72) Inventors: HONG HYUN YANG, GYEONGGI-DO (KR); KYUNG HO LEE, INCHEON (KR); SUNG YEOL CHOI, GANGWON-DO (KR)

(21) Appl. No.: 18/766,041

(22) Filed: Jul. 8, 2024

(30) Foreign Application Priority Data
Nov. 1, 2023 (KR) 10-2023-0148680

(51) Int. Cl. G06Q 10/083; G06Q 10/0833

(52) U.S. Cl. CPC G06Q 10/0838; G06Q 10/0833

(57) ABSTRACT

There is an apparatus for recovering errors in supply chain transaction information. The apparatus includes a memory that stores at least one instruction; and a processor, wherein, when the at least one instruction is executed by the processor, a map is prepared based on a plurality of pieces of event information from two or more players involved in a manufacturing or distribution process of a specific product, and each of the plurality of pieces of event information includes transaction information on the supply chain of the product, and error event information that is lost or has outliers among the plurality of pieces of event information is recovered by acquiring and using history information transmitted and received between the players from the map.

### CROSS-REFERENCE TO RELATED PATENT APPLICATION

This non-provisional U.S. patent application is based on and claims priority under 35 U.S.C. § 119 of Korean Patent Application No. 2023-0148680 filed on November 01, in the Korean Intellectual Property Office, the entire contents of which are hereby incorporated by reference.

### BACKGROUND

### 1. Technical Field

The present disclosure relates to an apparatus and method for recovering errors in supply chain transaction information, and more particularly, to providing a technology for recovering errors such as missing values or outliers in data on a supply chain.

### 2. Related Art

The world is joining forces to build smart distribution and logistics ecosystems through standardized digital transformation with the goal of sustainability. Global Standards1 (GS1), which is a non-profit international standard organization for global distribution and logistics, plays a pivotal role in building a smart distribution logistics ecosystem.

The GS1 is developing tracing standards and guidelines for rail, maritime transportation, and air logistics to improve history trace visibility in distribution and logistics and meet consumer satisfaction, and may be applied to agricultural products as well as industrial products.

In addition, the ultimate goal is to establish standard documents that may implement the history trace on the existing GS1 standards such as a GS1 identification system, one and two-dimensional barcodes and radio frequency identification (RFID), Electronic Product Code Information Services Standard (EPCIS) & Core Business Vocabulary (CBV), Electronic Data Interchange (EDI), and Global Data Synchronization Network (GDSN), as well as implementation guidelines for various industry sectors.

This GS1 international standard is a standard that will best realize data industry, which is a core of 4^{th} Industrial Revolution era, and is expanding its scope not only to transportation and logistics, but also to distribution, healthcare, smart factories, and national defense.

Recently, the demand for product traceability is increasing in various industries for consumer safety, and accordingly, the need for trace and management of the supply chain of products including food, industrial products, or the like is also emerging. For example, in the case of food, even if there is a risk of degeneration, contamination, or terrorism, it is not easy to prepare for the degeneration, contamination, or terrorism in reality. In particular, information asymmetry is a major obstacle to such preparation.

Therefore, by recording and managing various types of information generated during the manufacturing and/or distribution process of products as a history, technologies need to be developed to allow not only each player involved in the manufacturing and/or distribution process, but also consumers who consume products to trace their histories.

### SUMMARY

The tracing of the supply chain described above assumes that data received from each player that constitutes the supply chain is stored intact. However, in some cases, errors may present in the above-described data due to various circumstances. For example, errors such as loss of specific data or outliers may present.

The present disclosure provides a technology for recovering the errors when the errors present, and furthermore, provides an apparatus and method for recovering errors in supply chain transaction information capable of smoothly tracing the supply chain based on the recovered information.

The problems to be solved by the present disclosure are not limited to the above-mentioned problems, and other problems that are not mentioned may be obviously understood by those skilled in the art from the following description.

In accordance with an aspect of the present disclosure, there is an apparatus for recovering errors in supply chain transaction information. The apparatus includes a memory that stores at least one instruction; and a processor, wherein, when the at least one instruction is executed by the processor, a map is prepared based on a plurality of pieces of event information from two or more players involved in a manufacturing or distribution process of a specific product, and each of the plurality of pieces of event information includes transaction information on the supply chain of the product, and error event information that is lost or has outliers among the plurality of pieces of event information is recovered by acquiring and using history information transmitted and received between the players from the map.

Further, the event information may include at least one of first information on a received product, second information on a shipped product, and third information on an action that occurs between the warehousing and the shipping, based on each of the players.

Further, the processor may execute the at least one instruction to recover error event information in one of the players using second information from a player connected to one of the players in a parent relationship and first information from the player connected to one of the players in a child relationship.

Further, the processor may execute the at least one instruction to recover event information lost in each of two or more consecutively connected players among the players by allocating the two or more consecutively connected players to one node, and during the recovery process, first information on a product received by a preceding player is recovered using second information from a player connected in a parent relationship with the preceding player at the node, and second information on a product shipped to a following player is recovered using first information from a player connected to the following player at the node in a child relationship.

Further, the player connected to the one player in the parent relationship or the player connected to the one player in the child relationship may be a plurality of players, and the error event information in one of the players is recovered using at least one of a result of summing the second information from each of the plurality of players connected in the parent relationship and a result of summing the first information from each of the plurality of players connected in the child relationship.

Further, the map may be prepared to comply with a predetermined standard for supply chain transaction information.

Further, the standard for supply chain transaction information may be a protocol based on predetermined grammar, and the process of analyzing the plurality of event information or generating the map to generate the map is prepared to operate based on the grammar without a user handling the grammar.

Further, the product may be attached with an electronic identification code, and the processor executes the at least one instruction to provide the map to which the electronic identification code points when scan information obtained by scanning an electronic identification code is received or at least one piece of event information included in the map based on the scan information as a response to the reception.

In accordance with another aspect of the present disclosure, there is a method of recovering errors in supply chain transaction information, which is performed by an apparatus. The method includes acquiring a plurality of pieces of event information from two or more players involved in a manufacturing or distribution process of a specific product, each of the plurality of pieces of event information including information on the supply chain of the product; generating a map based on the plurality of pieces of acquired event information; acquiring history information transmitted and received between the players from the generated map; and recovering event information that is lost or has outliers among the plurality of pieces of event information based on the acquired history information.

Further, the event information may include at least one of first information on a received product, second information on a shipped product, and third information on an action that occurs between the warehousing and the shipping, based on each of the players.

### BRIEF DESCRIPTION OF DRAWINGS

FIG. 1 is a diagram illustrating a structure of an electronic product code (EPC) global network according to an embodiment of the present disclosure.

FIG. 2 is a diagram illustrating a network structure of a system for tracing supply chain transaction information based on an EPC global network according to an embodiment of the present disclosure.

FIG. 3 is a flowchart illustrating operations of the incinerator control system according to an embodiment of the present disclosure.

FIG. 4 is a diagram illustrating a configuration of an apparatus for recovering errors in supply chain transaction information according to an embodiment of the present disclosure.

FIG. 5 is a diagram illustrating a method of recovering errors in supply chain transaction information according to an embodiment of the present disclosure.

FIG. 6 is a diagram illustrating an example of a supply chain scenario A according to an embodiment of the present disclosure.

FIG. 7 is a diagram illustrating an operation of recovering error event information to generate a final map according to an embodiment of the present disclosure.

FIG. 8 is a diagram illustrating an example of a supply chain scenario B according to an embodiment of the present disclosure.

### DESCRIPTION OF EXAMPLE EMBODIMENTS

Hereafter, embodiments of the present disclosure will be described in detail with reference to the accompanying drawings and the same or similar components are given the same reference numerals regardless of the numbers of figures and are not repeatedly described. In addition, terms “module” and “unit” for components used in the following description are used only to easily make the disclosure. Therefore, these terms do not have meanings or roles that distinguish from each other in themselves. Further, when it is decided that a detailed description for the known art related to the present disclosure may obscure the gist of the present disclosure, the detailed description will be omitted. Further, the accompanying drawings are provided only for easy understanding of embodiments disclosed in the specification, the technical spirit disclosed in the specification is not limited by the accompanying drawings, and all changes, equivalents, and replacements should be understood as being included in the spirit and scope of the present disclosure.

Terms including ordinal numbers such as “first,” “second,” etc., may be used to describe various components, but the components are not to be construed as being limited to the terms. The terms are used only to distinguish one component from another component.

It is to be understood that when a first element is referred to as being “connected to” or “coupled to” a second element, the first component may be connected directly to or coupled directly to the second element or be connected to or coupled to the second element with other elements intervening therebetween. On the other hand, it should be understood that when a first element is referred to as being “connected directly to” or “coupled directly to” a second element, it may be connected to or coupled to the second element without other elements interposed therebetween.

It will be further understood that terms “include” and “have” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

In the present specification, the term “unit” includes a unit implemented by hardware, a unit implemented by software, and a unit implemented by both the hardware and software. Further, one unit may be implemented by two or more pieces of hardware, and two or more units may be implemented by one piece of hardware.

In the present specification, some of the operations or functions described as performed by a terminal, an apparatus, or a device may be performed instead in a server connected to the corresponding terminal, apparatus, or device. Similarly, some of the operations or functions described as being performed by a server may be performed in a terminal, an apparatus, or a device connected to the corresponding server.

In this specification, the description is limited to “error recovery apparatus 100 for tracking supply chain transaction information,” but is a terminal for providing a supply chain transaction information service that may trace a manufacturing or distribution process for a specific product based on a separate platform, and may include various apparatuses capable of performing calculation processing. That is, the error recovery apparatus 100 may further include a server, a computer, a server, and/or a portable terminal, or may take the form of any one of them, but is not limited thereto. However, for convenience of description, the description will be made based on a separate platform built to support the supply chain transaction information tracking service. For this purpose, a separate application or web page may be provided.

Here, the computer may include, for example, a notebook computer, a desktop computer, a laptop computer, a tablet personal computer (PC), a slate PC, etc., that are equipped with a web browser.

The server is a server that processes information by communicating with external devices, and may include an application server, a computing server, a database server, a file server, a game server, a mail server, a proxy server, a web server, and the like.

The portable terminal is, for example, a wireless communication device that ensures portability and mobility, and may include all types of handheld-based wireless communication devices such as a personal communication system (PCS), global system for mobile communication (GSM), personal digital cellular (PDC), a personal handyphone system (PHS), a personal digital assistant (PDA), international mobile telecommunication (IMT)-2000, code division multiple access (CDMA)-2000, W-code division multiple access (W-CDMA), a wireless broadband Internet (WiBro) terminal, and a smart phone, and wearable devices such as a watch, a ring, a bracelet, an anklet, a necklace, glasses, contact lenses, or a head-mounted-device (HMD).

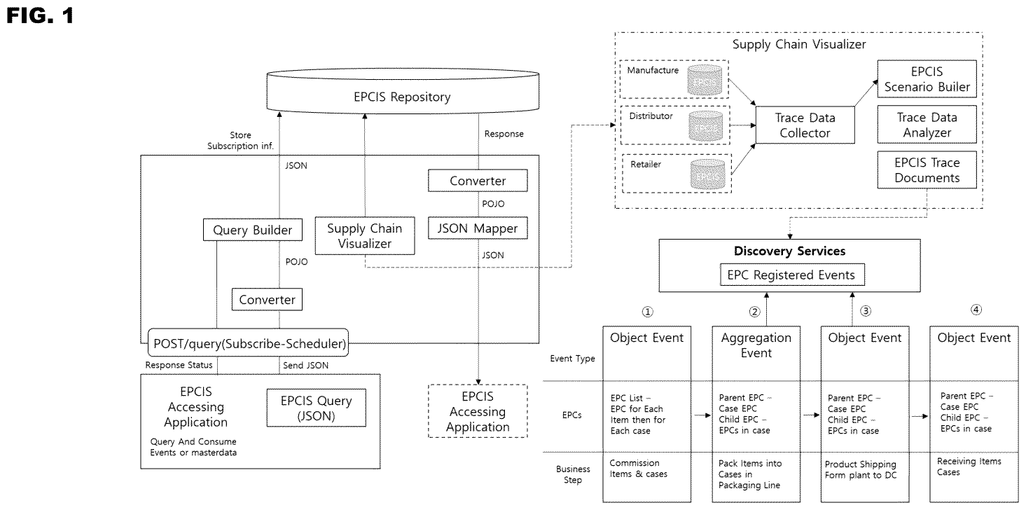

Hereinafter, operating principles and embodiments of the present disclosure will be described with reference to FIGS. 1 to 8.

FIG. 1 is a diagram illustrating a structure of an electronic product code (EPC) global network according to an embodiment of the present disclosure.

Looking at an electronic product code (EPC) global network with reference to FIG. 1, the EPC global network uses electronic identification codes, such as radio frequency identification (RFID) tags equipped with EPC, and a reader capable of recognizing the electronic identification codes to automatically identify products and objects and shares the identified information on networks, such as the Internet, to inquire locations of the products, so it is possible to manage the global supply chain.

Data generated from the EPC global network is primarily provided to stakeholders who need information and stored in an Electronic Product Code Information Services Standard (EPCIS) repository to be identified.

Among the components of the EPCIS system, the EPCIS repository, which continuously stores and manages a large amount of EPCIS event information (data) input from devices such as numerous RFID terminals, stores the corresponding EPCIS event information in a database to continuously process a large amount of data when multiple processes access simultaneously.

The ECPIS provides standardized XML-based Capture & Query Interfaces to enable ‘Track & Trace’ of products even in a global environment through standardized interfaces, thereby increasing product visibility. The EPCIS serves as a hub for collecting corporate EPC data. For this purpose, in the present disclosure, a module for acquiring event information (trace data collector), a module (trace data analyzer) for analyzing event information, and/or a module (EPCIS scenario builder) for reflecting the analyzed results on a supply chain scenario of a specific product among the plurality of supply chain scenarios (EPCIS trace documents) may be prepared.

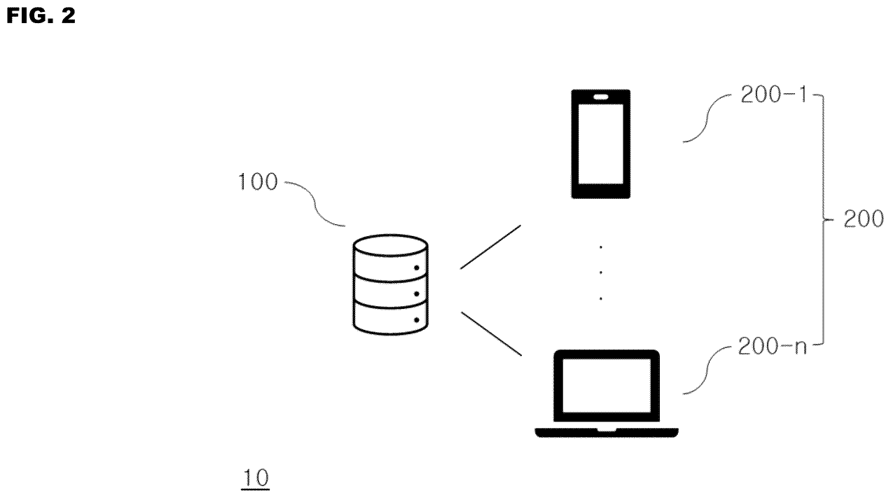

FIG. 2 is a diagram illustrating a network structure of a system for tracing supply chain transaction information based on an EPC global network according to an embodiment of the present disclosure.

Referring to FIG. 2, a system 10 for tracing supply chain transaction information (hereinafter referred to as “tracking system”) may include the error recovery apparatus 100 for recovering errors in supply chain transaction information and at least one player terminal 200. Here, the error recovery apparatus 100 corresponds to a supply chain visualizer of FIG. 1.

First, the error recovery apparatus 100 acquires at least one piece of event information that occurs during the manufacturing or distribution process of a specific product from each of the at least one player terminal 200. Here, the event information goes through the manufacturing or distribution process and includes at least one event input by the player terminal 200 corresponding to the process.

That is, the error recovery apparatus 100 may acquire at least one event by allowing the player terminal 200 to input at least one event that occurs during the manufacturing or distribution process through a separate platform (application or web page).

In addition, the error recovery apparatus 100 analyzes the at least one piece of event information to comply with a predetermined supply chain transaction information standard and reflects the at least one information on a supply chain scenario related to a specific product among a plurality of supply chain scenarios to generate a map for tracing the manufacturing or distribution process of the specific product.

Meanwhile, when the event information is acquired from each player terminal 200, the error recovery apparatus 100 may generate an electronic identification code including the event information.

Specifically, the electronic identification code is generated based on the event information acquired each time the specific product goes through the manufacturing or distribution process. In this case, when there is at least one process that precedes the manufacturing or distribution process, the electronic identification code includes not only the event information on the process, but also at least one piece of event information on the preceding process. In other words, the electronic identification code may be used as a means that may import the map for the specific product generated by the error recovery apparatus 100 or at least one piece of event information included in the map and provide records the recent history (including manufacturing, processing, distribution, etc.) for the specific product. In other words, the error recovery apparatus 100 may provide the map to which the electronic identification code is pointing or at least one piece of event information included in the map as a history.

Here, the electronic identification code may be generated in the form of at least one of an electronic product code (EPC), a quick response (QR) code, and a barcode, and players, consumers, etc., may scan the electronic identification code to receive a production history for the specific product. In other words, when the error recovery apparatus 100 acquires the information on the electronic identification code corresponding to the specific product from a terminal (player terminal, consumer terminal, etc.) possessed by a player, a consumer, etc., the error recovery apparatus 100 provides the map pointing to the acquired information or at least one piece of event information included in the map. In this case, the information on the electronic identification code may be acquired by scanning or by being input manually, and the method of acquiring the information is not limited.

Meanwhile, a situation may occur in which some pieces of the event information received from each of the plurality of player terminals 200 are lost or not received. Alternatively, some pieces of the already received event information may include outliers. In other words, errors may occur.

In this case, various problems may occur. For example, the tracing on the above-described map may not be performed smoothly. Alternatively, the above-described map may not be generated properly.

Accordingly, in an embodiment, the recovery of the event information that is lost, not received, or has outliers may be performed by the error recovery apparatus 100. In addition, by using the error recovery result, the above-described map may be generated properly, or the tracing on the above-described map may be performed normally.

Meanwhile, when the event information is acquired from each player terminal 200, the error recovery apparatus 100 may generate the electronic identification code including the event information. Specifically, the electronic identification code is generated based on the event information acquired each time the specific product goes through the manufacturing or distribution process. In this case, when there is at least one process that precedes the manufacturing or distribution process, the electronic identification code includes not only the event information on the process, but also at least one piece of event information on the preceding process.

In other words, the electronic identification code may be used as a means that may import the map for the specific product generated by the error recovery apparatus 100 or at least one piece of event information included in the map, and provide the recent history information on the specific product. In other words, the error recovery apparatus 100 may provide the map to which the electronic identification code is pointing or at least one piece of event information included in the map as a history.

Here, the electronic identification code may be generated in the form of at least one of an electronic product code (EPC), a quick response (QR) code, and a barcode, and players, consumers, etc., may scan the electronic identification code to receive the history information on the specific product. In other words, when the error recovery apparatus 100 receives the scan information obtained by scanning the electronic identification code attached to (included in) the specific product from a terminal (player terminal, consumer terminal, etc.) possessed by a player, a consumer, etc., the error recovery apparatus 100 provides the map to which the electronic identification code is pointing or at least one piece of event information included in the map based on the scan information as a response to the reception.

To this end, the error recovery apparatus 100 may provide a platform such as a separate application or web page to provide the supply chain transaction information tracing service as well as an artificial intelligence-based dictionary learning model.

Meanwhile, at least one player terminal 200 is a terminal possessed by each player (user, manager, official, person in charge, etc.) involved in the manufacturing or distribution of a specific product, and player terminals 200-1, . . . , and 200-n input and store at least one event that occurs during its manufacturing or distribution process on the platform provided by the error recovery apparatus 100, thereby automatically generating the event information.

In addition, at least one player terminal 200 may be a computer, an ultra mobile PC (UMPC), a workstation, a net-book, personal digital assistants (PDA), a portable computer, a web tablet, a wireless phone, a mobile phone, a smart phone, a pad, a smart watch, a wearable terminal, an e-book, a portable multimedia player (PMP), a portable game console, a navigation device, a black box, a digital camera, other mobile communication terminals, etc., in which each player may install and run the desired application programs (i.e., applications). That is, at least one player terminal 200 may be provided in various forms, but is not limited thereto.

Meanwhile, although not illustrated in FIG. 2, the tracking system 10 may further include at least one consumer terminal (not illustrated). The consumer terminal may scan the electronic identification code generated by the error recovery apparatus 100 and thus receive the map for the specific product corresponding thereto or at least one piece of event information included in the map based on a preset template.

Specifically, a consumer who purchases a specific product may scan the electronic identification code attached to the specific product through the consumer terminal he or she possesses, so the consumer may identify the history based on the preset template through the platform provided by the error recovery apparatus 100 as the map for the specific product or at least one piece of event information included in the map is visually displayed on the display.

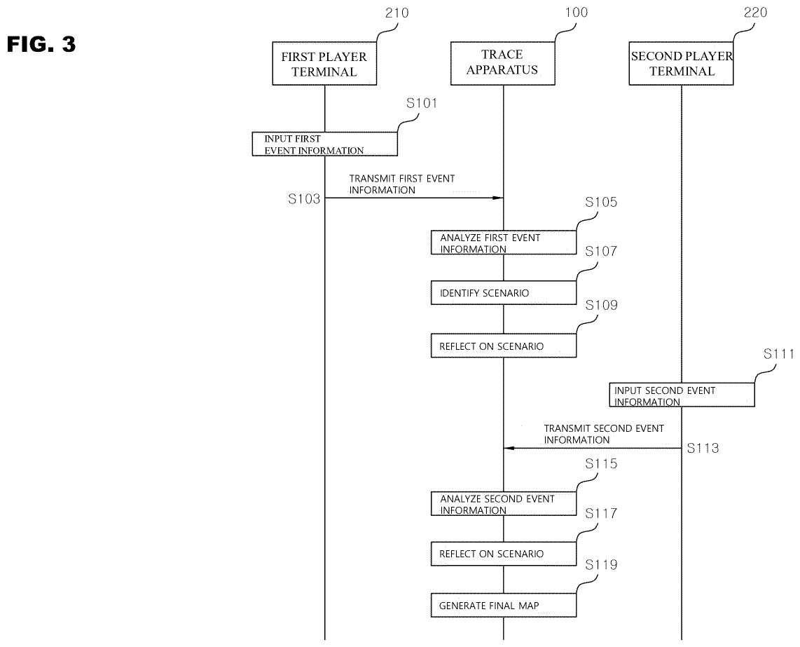

FIG. 3 is a flowchart illustrating an operation of a system for tracing supply chain transaction information according to an embodiment of the present disclosure, and it is limited to the case of generating the map for the specific product produced through a first manufacturing process by the first player and a second manufacturing process by the second player. However, this is only an example for convenience of description, and the number of player terminals and each operation may be added or omitted depending on a series of production processes and the number of players involved in each production process.

FIG. 3 is a flowchart illustrating an operation of a system for tracing supply chain transaction information according to an embodiment of the present disclosure, and it is limited to the case of generating the map for the specific product produced through the first manufacturing process by the first player and the second manufacturing process by the second player. However, this is only an example for convenience of description, and the number of player terminals and each operation may be added or omitted depending on a series of production processes and the number of players involved in each production process.

Referring to FIG. 3, when the production of the specific product begins, if the first event information including at least one event that occurs in the first manufacturing process is input to a platform through a first player terminal 210 (S101), the first player involved in the first manufacturing process transmits the input first event information to the error recovery apparatus 100 (S103).

Next, the error recovery apparatus 100 analyzes the first event information received in operation S103 to comply with the predetermined supply chain transaction information standard (S105), supplies the supply chain scenario related to the specific product among the plurality of supply chain scenarios (S107), and then reflects the results analyzed in operation S105 on the identified supply chain scenario (S109). Here, the above-described operation S107 may not be performed according to the embodiment.

Next, when the second event information including at least one event that occurs in the second manufacturing process is input to the platform through the second player terminal 220 (S111), the second player terminal 220 involved in the second manufacturing process transmits the input second event information to the error recovery apparatus 100 (S113).

Next, the error recovery apparatus 100 analyzes the second event information received in operation S113 to comply with the predetermined supply chain transaction information standard (S115), and reflects the results analyzed in operation S115 on the supply chain scenario related to the specific product (S117).

As a result, as the entire production process of the specific product is performed, a scenario reflecting all the results analyzed for the event information of each manufacturing process is generated as a map (S119). In this case, in operation S119, it is checked whether there is the event information that is lost or includes outliers to finally generate a map.

Meanwhile, although not illustrated in FIG. 3, when performing operations S109 and S119, the error recovery apparatus 100 may generate the electronic identification code, respectively. In addition, not all operations included in operations S101 to S109 illustrated in FIG. 3 are performed before operations S111 to S117 are performed. That is, according to the embodiment, the execution sequence from operation S101 to operation S117 may be performed differently from that illustrated in FIG. 3. For example, operation S101 may be performed followed by operation S111, and then operation S103 may be performed. Alternatively, of course, operation S111 may be performed first and then operation S101 may be performed.

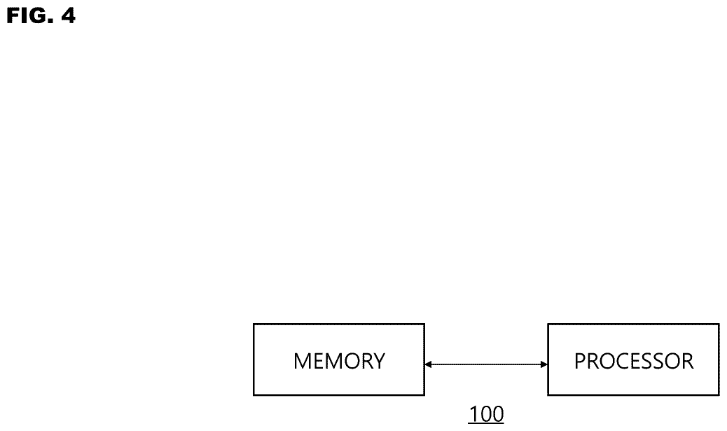

FIG. 4 is a diagram illustrating a configuration of an apparatus for recovering errors in supply chain transaction information according to an embodiment of the present disclosure.

Referring to FIG. 4, the apparatus 100 for recovering errors in supply chain transaction information (or, may also be referred to as a map generation apparatus) according to the embodiment of the present disclosure may include a memory 110 and a processor 120.

The memory 110 may store data on at least one process (algorithm) for recovering errors in supply chain transaction information or a program that reproduces the process. In addition, the memory 110 may further store processes for performing other operations, but is not limited thereto. Here, the above-described process may refer to a series of operations performed by allowing the processor 120 to execute at least one instruction, but is not limited thereto.

Meanwhile, the memory 110 may store various types of information on at least one product, various types of information on at least one player involved in the production process of each product, and a plurality of supply chain scenarios. In addition, the memory 110 may store at least one pre-learning model (including a language model) used in the supply chain transaction information tracing service, and various data supporting various functions of the error recovery apparatus 100 such as each template (format), instrument, tool, etc., for visually providing a history of each product.

In addition, the memory 110 may store a plurality of application programs (application programs or applications) running on the error recovery apparatus 100, and data and instructions for the operation of the error recovery apparatus 100. At least some of these application programs may be downloaded from the external server via the wireless communication. Meanwhile, the application program may be stored in at least one memory provided in the memory 110 and installed on the error recovery apparatus 100, and may be run to perform an operation (or function) by at least one processor stored in the memory 110 through the processor 120.

Meanwhile, the memory 110 may include at least one, and at least one memory may include at least one type of storage medium of a flash memory type storage medium, a hard disk type storage medium, a multimedia card micro type storage medium, a card type memory (for example, an SD or XD memory, or the like), a random access memory (RAM), a static RAM (SRAM), a read-only memory (ROM), an electrically erasable programmable ROM (EEPROM), a programmable ROM (PROM), a magnetic memory, a magnetic disk, and an optical disk. In addition, the memory may store information temporarily, permanently, or semi-permanently, and may be provided as a built-in or removable type.

The memory 110 may not only be used to build an environment in which the event information by each player may be shared or integrated, but may also be further linked with a separate external server.

In addition to operations related to the application program, the processor 120 may control all components within the error recovery apparatus 100 based on at least one processor to process input or output signals, data, information, etc., execute instructions, algorithms, or applications stored in at least one memory to execute various processes, and provide or process appropriate information or functions to recover errors in supply chain transaction information based on event information by each player.

The processor 120 may execute at least one instruction stored in the memory 110. As a result, an operation of recovering errors in the supply chain transaction information is executed.

Specifically, by allowing the processor 120 to execute at least one instruction, the map generated based on a plurality of pieces of event information from two or more players involved in the manufacturing or distribution process of the specific product is prepared. In this case, each of the plurality of pieces of event information includes the transaction information on the supply chain of the specific product. In addition, by allowing the processor 120 to execute at least one instruction, the processor 120 acquires and uses the history information transmitted and received between the players from the previously generated map, thereby recovering the error event information that is lost or has outliers among the plurality of pieces of event information.

In this case, the processor 120 executes at least one instruction, analyzes the event information acquired from each player when generating the map to comply with the supply chain transaction information standard and reflects the analyzed event information on the supply chain scenario related to the specific product to record that history.

Here, the standard for the supply chain transaction information is a convention based on predetermined grammar, and the product-related supply chain scenario is for designing a new supply chain or monitoring the supply chain of the product that is already in distribution.

Meanwhile, the event information may include at least one of the first information on the received product, the second information on the shipped product, and the third information on actions that occur between warehousing and shipping, based on each player that constitutes the product supply chain.

In this case, the processor 120 executes at least one instruction to process the first, second, and third information provided from each of the players involved in the manufacturing or distribution process to comply with the supply chain transaction information standard, and then analyzes each of pieces of the at least one piece of event information acquired.

Meanwhile, the error recovery apparatus 100 may acquire the event information from each player during the production process of the corresponding product. Here, each piece of event information may be generated differently depending on the type of production process, that is, the event type.

In addition, the processor 120 executes at least one instruction to control players to review whether a quantity shipped from a parent player matches a quantity stocked by a child player when the results analyzed based on each event information are reflected on the supply chain scenario for the corresponding product. For this purpose, the quantity shipped from the parent player may be identified through the second information included in the event information input from the parent player, and the quantity warehoused by the child player may be identified through the first information included in the event information input from the child player. Then, it may be reviewed whether the quantity shipped from the parent player matches the quantity warehoused from the child player connected thereto. In addition, the results reviewed in this way may be used to recover the above-described errors, such as the loss of event information or the outliers. Hereinafter, it will be described in more detail.

The processor 120 may execute at least one instruction to check whether the quantity shipped according to the second information of the parent player matches the quantity received according to the first information of the child player, thereby determining whether there is the above-described error, that is, the error event information that is lost or has outliers. When the shipped quantity according to the second information of the parent player does not match the warehoused quantity according to the first information of the child player, the error recovery apparatus 100 may determine that there is the error event information that is lost or has outliers, and may determine that there is no error event information that is lost or has outliers when the shipped quantity matches the warehoused quantity.

For example, the processor 120 executes at least one instruction to recover the error event information in the specific player among the players using at least one of the second information from the player connected to the specific player in the parental relationship and the first information from the player connected to the specific player in the child relationship.

In an embodiment, the processor 120 executes at least one instruction to determine the shipped quantity according to the second information of the parent player and the warehoused quantity according to the first information of the child player, which are identified based on one player, are each determined as the warehoused quantity and the shipped quantity of the event information lost by the one player when the error event information is generated in one player, that is, when the quantity warehoused to the one player and the quantity shipped from the one player are lost, thereby finally generating the map. Of course, in some cases, only the quantity warehoused for the one player or only the quantity shipped from one player may be lost, and even in this case, recovery is possible using the above-described information, etc.

In another embodiment, the processor 120 executes at least one instruction to combine and handle a plurality of players into one node when there is the plurality of pieces of error event information, for example, when the event information is lost from each of the plurality of players, thereby recovering the first information warehoused to the node using the shipped quantity according to the second information from the parent player identified based on the node and recovering the second information shipped from the node using the warehoused quantity according to the first information from the child player identified based on the node. The event information recovered in this way may be used to generate, trace, or the like the map described above.

In this case, since products warehoused in at least one of the players may be warehoused from at least two parent players or shipped products may be shipped to at least two child players, the processor 120 may control to execute at least one instruction to sum the shipped quantities according to the first information of each of the plurality of parent players when there are the plurality of parent players to determine the warehoused quantity of the error event information and sum the shipped quantities according to the second information of each of the plurality of child players when there are the plurality of child players to determine the warehoused quantity of the error event information.

For example, the processor 120 executes at least one instruction to recover the lost event information in each of two or more consecutively connected players among the players by assigning the two or more consecutively connected players to one node, and during the recovery process, recovers the first information on the product received by the preceding player using the second information from the player connected to the preceding player by the node in the parent relationship and recovers the second information on the shipped product to the following player using the first information from the player connected to the following player by the node in the child relationship.

Meanwhile, although not illustrated in FIG. 4, as illustrated on the supply chain visualizer in FIG. 1, the error recovery apparatus 100 may include a module (trace data analyzer) for analyzing the event information acquired to operate based on the grammar without the user handling the grammar or a module (EPCIS scenario builder) for reflecting the analyzed results on the scenario of the specific product among the plurality of supply chain scenarios (EPCIS trace documents). In addition, a module (trace data collector) for acquiring the event information from each of at least one player terminal 200 involved in the manufacturing or distribution process of the specific product may also be provided.

Meanwhile, although not illustrated in FIG. 4, the error recovery apparatus 100 may further include a communication unit.

The communication unit transmits and receives at least one piece of information or data to and from at least one device/terminal. Here, at least one apparatus/terminal may be the apparatus/terminal that wishes to receive test results by the error recovery apparatus 100, and the type and form thereof are not limited.

In addition, the communication unit may perform communication with other apparatuses and transmits and receives wireless signals in a communication network based on wireless Internet technologies.

Examples of the wireless Internet technologies include wireless LAN (WLAN), wireless-fidelity (Wi-Fi), Wi-Fi direct, digital living network alliance (DLNA), WiBro, world interoperability for microwave access (WiMAX), high speed downlink packet access (HSDPA), high speed uplink packet access (HSUPA), long term evolution (LTE), LTE-advanced (LTE-A), and the like. The error recovery apparatus 100 transmits and receives data according to at least one wireless Internet technology in a range including the Internet technologies not listed above.

The error recovery apparatus 100 is for short range communication, and may support short range communication using at least one of Bluetooth™, RFID, infrared data association (IrDA), ultra wideband (UWB), ZigBee, near field communication (NFC), Wi-Fi, Wi-Fi Direct, and wireless universal serial bus (wireless USB). The wireless area networks may support wireless communication between the error recovery apparatus 100 and at least one terminal. In this case, the short range wireless communication network may be wireless personal area networks.

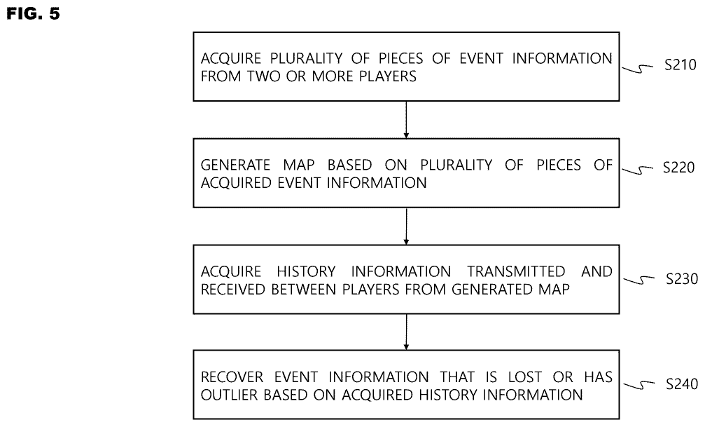

FIG. 5 is a diagram illustrating a method of recovering errors in supply chain transaction information according to an embodiment of the present disclosure.

Referring to FIG. 5, the error recovery apparatus 100 acquires the plurality of pieces of event information from two or more players involved in the manufacturing or distribution process of the specific product (S210), and generates the map based on the plurality of pieces of acquired event information (S220). Here, each of the plurality of pieces of event information includes the information on the supply chain of the product.

Next, the error recovery apparatus 100 acquires the history information transmitted and received between the players from the map generated in operation S220 (S230), and recovers the event information that is lost or has outliers among the plurality of pieces of event information based on the acquired history information (S240).

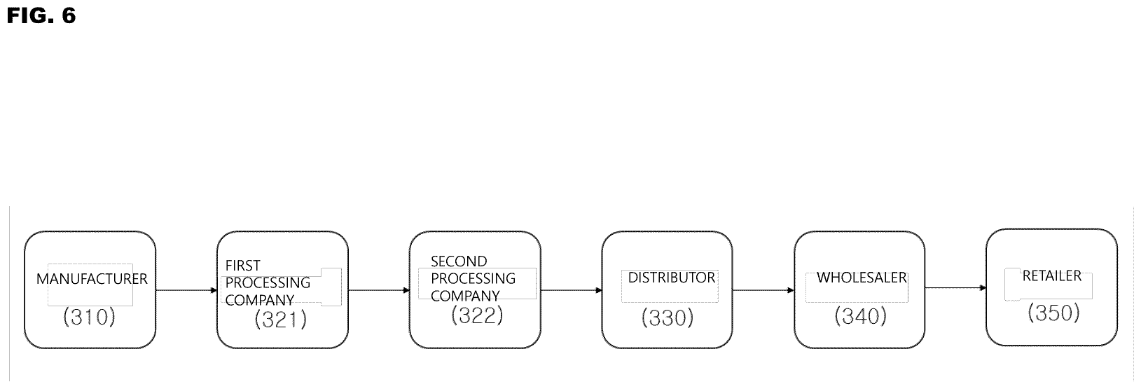

FIG. 6 is a diagram illustrating an example of a supply chain scenario A according to an embodiment of the present disclosure.

Prior to description, the supply chain scenario forms the supply chain by sequentially arranging ordering, processing (manufacturing), distribution, and sales (wholesale, retail) operations involved in the production process of the specific product.

Referring to FIG. 6, the supply chain scenario A is a player involved in the production process of the specific product, and illustrates an example in which the supply chain scenario A includes a manufacturer 310, a first processing company 321, a second processing company 322, a distributor 330, a wholesaler 340, and a retailer 350.

Specifically, the product may be primarily processed at the first processing company 321 based on the ordering information from the manufacturer 310, the primary processed product may be delivered to the second processing company 322 to be secondarily processed, and may then be delivered from the wholesaler 340 to the retailer 350 via the distributor 330. In other words, each player that constitutes the supply chain scenario A, that is, each company, is sequentially delivered to produce the specific product. In this case, the event information may be input to the platform by the company each time it passes through each company, so the electronic identification code may also be generated.

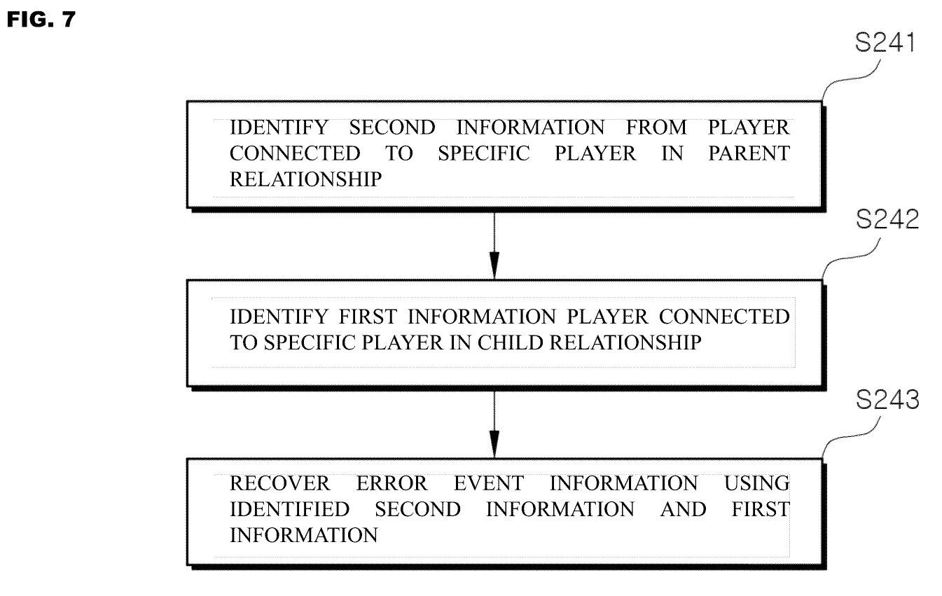

FIG. 7 is a diagram illustrating an operation of recovering the error event information and generating the final map according to an embodiment of the present disclosure, and specifically illustrates the operation S240 of FIG. 5.

Referring to FIG. 7, when there is a specific player with the error event information, the error recovery apparatus 100 identifies the second information from the player connected to the specific player in the parent relationship (S241), and identifies the first information from the player connected to the specific player in the child relationship (S242).

Next, the error recovery apparatus 100 recovers the error event information using the second information identified in operation S241 and the first information identified in operation S242 (S243).

However, FIG. 7 is only one embodiment, and operation S242 may be performed before operation S241, and the order in which operations S241 and S242 are performed is not limited.

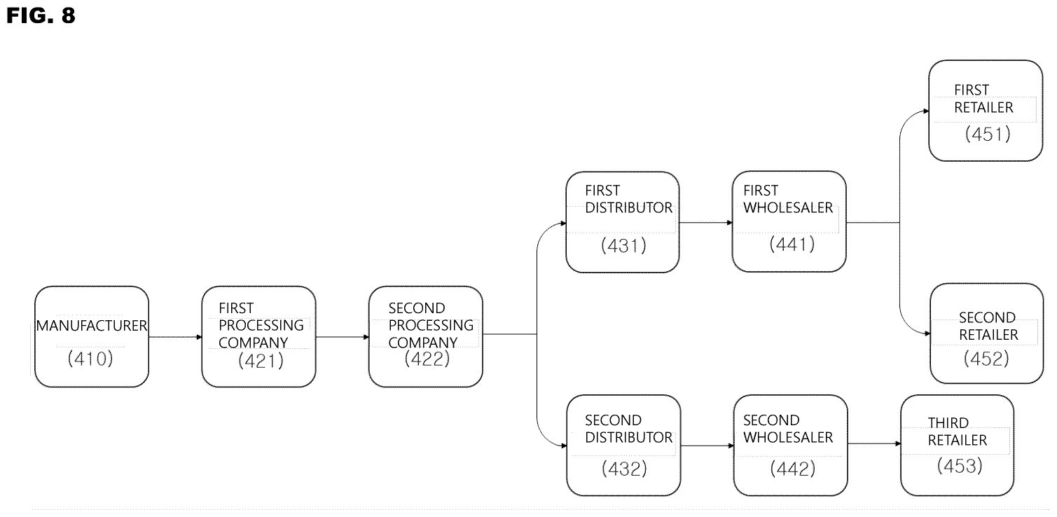

FIG. 8 is a diagram illustrating an example of a supply chain scenario B according to another embodiment of the present disclosure, and is illustrated to describe a case where there are the plurality of parent players and/or child players.

Referring to FIG. 8, the supply chain scenario B is a player involved in the production process of the specific product, and illustrates an example in which the supply chain scenario B includes a manufacturer 410, a first processing company 421, a second processing company 422, a first distributor 431, a second distributor 432, a first wholesaler 441, a second wholesaler 442, a first retailer 451, a second retailer 452, and a third retailer 453.

Specifically, the product may be primarily processed at the first processing company 421 based on the ordering information from the manufacturer 410, the primary processed product may be delivered to the second processing company 422 to be secondarily processed, and then the secondarily processed product may be delivered from the first distributor 431 and the second distributor 432, respectively. Thereafter, some of the products may be delivered to the first wholesaler 441 through the first distributor 431 and then delivered to the first retailer 451 and the second retailer 452, respectively. Meanwhile, the remaining products among the products may be delivered to the second wholesaler 442 through the second distributor 432 and then delivered to the third retailer 453.

Accordingly, the child player of the second processing company 422 become the first distributor 431 and the second distributor 432, that is, becomes the plurality of child players.

Meanwhile, although not illustrated in FIG. 8, similarly, when parts produced from each of the two first processing companies are received and one product is completed in the second processing company, the second processing company has the plurality of child players.

In other words, the number of parent players and child players is not limited, and may be set or changed when designing the supply chain scenario according to a manufacturing plan by the manufacturer ordering the specific product.

In order for the computer to read the program and execute the methods implemented as the program, the program may include a code coded in a computer language such as C, C++, JAVA, or machine language that the processor (CPU) of the computer may read through a device interface of the computer. Such code may include a functional code related to a function or such defining functions necessary for executing the methods and include an execution procedure related control code necessary for the processor of the computer to execute the functions according to a predetermined procedure. In addition, the code may further include a memory reference related code for which location (address street number) in an internal or external memory of the computer the additional information or media necessary for the processor of the computer to execute the functions is to be referenced at. In addition, when the processor of the computer needs to communicate with any other computers, servers, or the like located remotely in order to execute the above functions, the code may further include a communication-related code for how to communicate with any other computers, servers, or the like using the communication module of the computer, what information or media to transmit/receive during communication, and the like.

The storage medium is not a medium that stores videos therein for a while, such as a register, a cache, a memory, or the like, but means a medium that semi-permanently stores the videos therein and is readable by an apparatus. Specifically, examples of the storage medium include, but are not limited to, a ROM, a RAM, a compact disc ROM (CD-ROM), a magnetic tape, a floppy disk, an optical image storage device, and the like. That is, the program may be stored in various recording media on various servers accessible by the computer or in various recording media on the computer of the user. In addition, media may be distributed in a computer system connected by a network, and a computer-readable code may be stored in a distributed manner.

Operations of the method or algorithm described with reference to the embodiment of the present disclosure may be directly implemented in hardware, in software modules executed by hardware, or in a combination thereof. The software module may reside in a RAM, a ROM, an erasable programmable ROM (EPROM), an EEPROM, a flash memory, a hard disk, a removable disk, a CD-ROM, or in any form of computer-readable recording media known in the art to which the preset disclosure pertains.

Although exemplary embodiments of the present invention have been described with reference to the accompanying drawings, those skilled in the art to which the present disclosure belongs will appreciate that various modifications and alterations may be made without departing from the spirit or essential feature of the present invention. Therefore, it is to be understood that embodiments described above are illustrative rather than being restrictive in all aspects.

What is claimed is:

1. An apparatus for recovering errors in supply chain transaction information, comprising:
a memory that stores at least one instruction; and
a processor,
wherein, when the at least one instruction is executed by the processor,
a map is prepared based on a plurality of pieces of event information from two or more players involved in a manufacturing or distribution process of a specific product, and each of the plurality of pieces of event information includes transaction information on the supply chain of the product, and
error event information that is lost or has outliers among the plurality of pieces of event information is recovered by acquiring and using history information transmitted and received between the players from the map.

2. The apparatus of claim 1, wherein the event information includes at least one of first information on a received product, second information on a shipped product, and third information on an action that occurs between the warehousing and the shipping, based on each of the players.

3. The apparatus of claim 2, wherein the processor executes the at least one instruction to recover error event information in one of the players using second information from a player connected to one of the players in a parent relationship and first information from the player connected to one of the players in a child relationship.

4. The apparatus of claim 2, wherein the processor executes the at least one instruction to recover event information lost in each of two or more consecutively connected players among the players by allocating the two or more consecutively connected players to one node, and
during the recovery process, first information on a product received by a preceding player is recovered using second information from a player connected in a parent relationship with the preceding player at the node, and
second information on a product shipped to a following player is recovered using first information from a player connected to the following player at the node in a child relationship.

5. The apparatus of claim 3, wherein the player connected to the one player in the parent relationship or the player connected to the one player in the child relationship is a plurality of players, and
the error event information in one of the players is recovered using at least one of a result of summing the second information from each of the plurality of players connected in the parent relationship and a result of summing the first information from each of the plurality of players connected in the child relationship.

6. The apparatus of claim 1, wherein the map is prepared to comply with a predetermined standard for supply chain transaction information.

7. The apparatus of claim 6, wherein the standard for supply chain transaction information is a protocol based on predetermined grammar, and
the process of analyzing the plurality of event information or generating the map to generate the map is prepared to operate based on the grammar without a user handling the grammar.

8. The apparatus of claim 1, wherein the product is attached with an electronic identification code, and
the processor executes the at least one instruction to provide the map to which the electronic identification code points when scan information obtained by scanning an electronic identification code is received or at least one piece of event information included in the map based on the scan information as a response to the reception.

9. A method of recovering errors in supply chain transaction information, which is performed by an apparatus, the method comprising:
acquiring a plurality of pieces of event information from two or more players involved in a manufacturing or distribution process of a specific product, each of the plurality of pieces of event information including information on the supply chain of the product;
generating a map based on the plurality of pieces of acquired event information;
acquiring history information transmitted and received between the players from the generated map; and
recovering event information that is lost or has outliers among the plurality of pieces of event information based on the acquired history information.

10. The apparatus of claim 9, wherein the event information includes at least one of first information on a received product, second information on a shipped product, and third information on an action that occurs between the warehousing and the shipping, based on each of the players.
